(19) United States
(12) Patent Application Publication
(10) Pub. No.: US 2004/0159144 A1
(43) Pub. Date: Aug. 19, 2004

(54) Method and device for performing a leak test on a gas generator

(76) Inventors: Thomas Abelen, Erftstadt (DE); Andreas Seiler, Wertheim (DE)

Correspondence Address: WALL MARJAMA & BILINSKI, 101 SOUTH SALINA STREET, SUITE 400, SYRACUSE, NY, 13202, US

(21) Appl. No.: 10/367,422

(22) Filed: Feb. 14, 2003

(51) Int. Cl. G01M 3/04; G01M 3/34

(52) U.S. Cl. 73/49.3; 73/40.7

(57) ABSTRACT

The invention relates to a method for performing a leak test on a gas generator (1), especially for airbags, according to which: the gas generator (1) is filled with a pressurized gas mixture, among other things, helium; the gas generator (1) filled with the gas mixture is introduced into a test chamber (2); gas is evacuated from the test chamber (2); the amount of helium exiting from a possibly present leak is determined with the aid of a sensor, and; the signal furnished by the sensor is used for determining the tightness/leakage of the gas generator (1). In order to accomplish the goal of performing a cost-effective search for leaks, the invention provides that the gas generator (1) is filled with a gas mixture whose helium proportion is equal to at least 50%.

### BACKGROUND OF THE INVENTION

1. Field of the Invention

The present invention relates generally to a method for performing leak tests, and particularly to a method for performing leak tests on a gas generator.

2. Technical Background

Gas generators, such as those employed as air bags, must meet stringent safety standards for obvious reasons. Before their deployment they are analyzed for leaks. Leakage typically must not exceed 10₋₈ mbar/s. The service life of air bags, for example, is of particular concern.

In one approach that has been considered, helium gas is injected into the gas generator for the purpose of integrally searching hollow, enclosed items for the presence of leaks. This is performed by introducing (injecting or bombing) helium at a low concentration before the test object is sealed or by exposing the test object in advance of a leak test to helium at high pressure. In other words, the gas generator is filled with a compressed gas (commonly CO₂) which includes a relatively small quantity of helium. Should a leak be present, a small quantity of helium will penetrate into the interior of the test object (gas generator). After the test object is exposed to the gas, it is disposed in a test chamber. A leak test is performed by evacuating the chamber to a specific predetermined pressure. If there is a leak present, a part of the helium present at a low concentration in the interior of the test object will migrate into the test chamber. The helium is detected with the aid of the sensor, commonly a mass spectrometer.

There are drawbacks to the above described approach. In order to attain the detection limits of this magnitude, it is required to evacuate the test chamber after having introduced the test object to relatively low pressures. In order to attain this goal, vacuum pumps capable of attaining sufficiently low base pressures need to be employed. In addition, there exists in the manufacture of gas generators the requirement of short cycle times. These can only be attained when the employed vacuum pumps offer, in addition, a high pumping capacity. For this reason leak detection instruments must necessarily employ relatively expensive pump systems capable of meeting the low base pressure requirements and high pumping capacities.

There are other drawbacks as well. Highly sensitive sensors must be employed to detect the very small amounts of helium present in the test chamber in the event of a leak in the wall of the gas generator. Currently, expensive mass spectrometers are being used to perform this task.

Thus, it is desirable to provide a cost effective method for performing high-sensitivity leak searching on gas generators, air bags in particular.

### SUMMARY OF THE INVENTION

The present invention addresses the problems and needs described above. The method and apparatus of the present invention provide a cost effective method for performing high-sensitivity leak searching on gas generators, such as air bags. The present invention relates to a method for performing a leak test on a gas generator, and is especially applicable to airbags. The gas generator is filled with a pressurized gas mixture that includes, among other things, helium. The gas generator is filled with the gas mixture and introduced into a test chamber. The gas is evacuated from the test chamber. The amount of helium exiting from a possibly present leak is determined with the aid of an inexpensive sensor. The signal furnished by the sensor is used for determining the tightness/leakage of the gas generator. Moreover, the present invention relates to a device suited for performing said method.

One aspect of the present invention is a method for performing a leak test on a gas generator. The method includes the steps of filling the gas generator with a pressurized gas mixture that includes helium, e.g., the gas generator is filled with a gas mixture whose helium proportion is equal to at least 50%. The gas generator (1) is introduced into a test chamber (2). The gas mixture is evacuated from the test chamber (2). An amount of helium is sensed exiting from a possibly present leak with a sensor device. The sensor is configured to provide a sensor signal. The amount of helium exiting from the possibly present leak is determined from the signal furnished by the sensor.

In another aspect, the present invention includes a method for performing a leak test on a gas generator. The method includes the steps of filling the gas generator with a pressurized gas mixture that includes helium, e.g., the gas generator is filled with a gas mixture whose helium proportion is approximately 100%. The gas generator is introduced into a test chamber. The gas mixture is evacuated from the test chamber. An amount of helium is sensed exiting from a possibly present leak with a sensor device. The sensor is configured to provide a sensor signal. The amount of helium exiting from the possibly present leak is determined from the signal furnished by the sensor.

In yet another aspect, the present invention includes an apparatus for performing a leak test on a gas generator. The apparatus includes a gas source configured to fill the gas generator with a pressurized gas mixture that includes helium. The gas mixture includes a helium proportion equal to at least 50%. A test chamber is configured to accommodate the gas generator. The test chamber includes at least one flexible wall. A gas evacuation mechanism is configured to evacuate the gas mixture from the test chamber (2). A sensor is configured to determine an amount of helium exiting from a possibly present leak. The sensor provides a signal corresponding to a measurement of the tightness/leakage of the gas generator. An analyzer is coupled to the sensor. The analyzer is configured to determine the tightness/leakage of the gas generator based on the signal received from the sensor.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is a cross-sectional view of the test apparatus.

### DETAILED DESCRIPTION

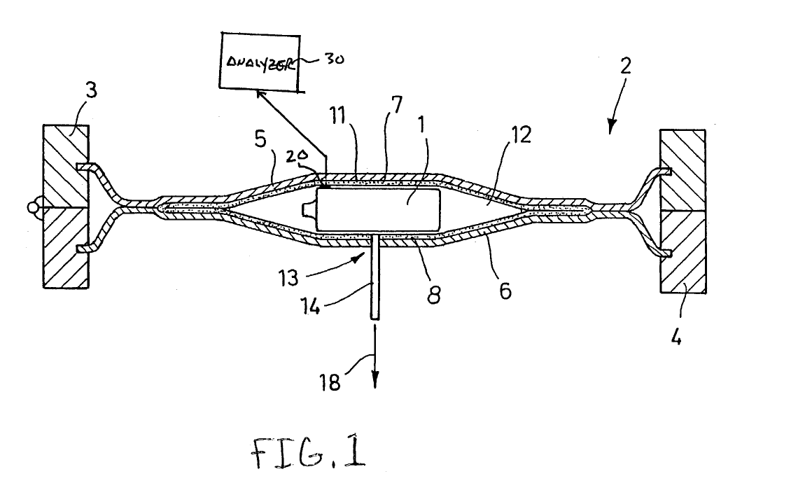

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the apparatus of the present invention is shown in FIG. 1, and is designated generally throughout by reference numeral 10.

In accordance with the invention, the present invention is directed to a method for performing a leak test on a gas generator. The method includes the steps of filling the gas generator with a pressurized gas mixture that includes helium, e.g., the gas generator is filled with a gas mixture whose helium proportion is equal to at least 50%. The gas generator (1) is introduced into a test chamber (2). The gas mixture is evacuated from the test chamber (2). An amount of helium is sensed exiting from a possibly present leak with a sensor device. The sensor is configured to provide a sensor signal. The amount of helium exiting from the possibly present leak is determined from the signal furnished by the sensor. Thus, the present invention addresses the problems and needs described in the Background Section. The method and apparatus of the present invention provide a cost effective method for performing high-sensitivity leak searching on gas generators, such as air bags.

As embodied herein, and depicted in FIG. 1, the leak test apparatus 10 includes foil test chamber 2. Foil test chamber includes a frame construction (frames 3 and 4). Foils 5 and 6 are shown as being clamped by frame 3 and frame 4. Foil 5 and foil 6 are flexible wall members. The foils 5 and 6 are equipped in the area of the test object 1 with porous foil sections 7, 8, which allow for a contiguous intermediate space 11 between the foils 5 and 6 on the one hand, and the test sample 1 on other hand. The drawing figure depicts a gas generator 1 containing at least 50% helium. The gas generator being filled by a gas source which is not shown for clarity of illustration. The gas generator was introduced into a foil test chamber 2.

In order to create the necessary test chamber 12 for leak searching the test object 1, the space between the foils 5, 6 is evacuated. Thus the foils 5 and 6 rest flush against the test object 1 thereby forming the test chamber 12 comprising intermediate space 11, formed by means 7, 8, and the volume of the test object 1.

The test chamber is evacuated through a central connection 13, which may be designed by way of a hose connection 14, for example, and which is joined to line I 18. The means 7, 8 forming the intermediate space do not extend in to the rim area of the foils 5, 6 so that the outer seal of the test chamber is performed in that the foils 5, 6 rest at their rim areas immediately flush against each other as soon as the evacuation commences. Further evacuation and the leak test is performed through the connection 13.

In the test chamber 12 a pressure is created which is sufficiently low to allow—in the instance of a leak—the test gas to be ejected from within the test object 1. The test gas is detected by an inexpensive detector sensitive to the test gas. The detector is connected at the intermediate space 11/test chamber 12. The detector/sensor 20 is connected to an analyzer 30. Sensor 20 transmits a signal to analyzer 30. The signal measures the amount of helium exiting from a possible leak that may be present. Thus, the signal corresponds to a measurement of the tightness/leakage of the gas generator (1). The analyzer is configured to determine the tightness/leakage of the gas generator (1) based on the signal received from the sensor. The analyzer may be resident on any suitable computing device (not shown). Those of ordinary skill in the art will recognize that the computing device is also coupled to a user interface which allows a user to view the results of the test.

In that the helium concentration in the gas generator to be tested is high, there is in the instance of a leak in the wall of the gas generator more helium present for determining the presence of the leak. In order to attain the demanded detection limits, pumps having a lower compression and/or lower pumping capacity may be employed. Faster cycle times can be attained. In all, there result through the present invention considerable cost related benefits.

Not only with respect to leak searching has it been found to be advantageous when the helium proportion in the gas mixture of the gas generator according to the present invention amounts to between 80% and almost 100%, preferably between 90% and almost 100%. Its is especially advantageous when the gas generator is filled exclusively with helium. Moreover, it is expedient within the scope of the present invention to employ for the purpose of performing the leak search, a test chamber equipped with at least one flexible wall. In the employment of such test chambers, the dead volume of the test chamber—test chamber volume after evacuation and during the helium detection process—is minimized. Thus the required pumping capacity can additionally be further significantly reduced and further cost advantages attained.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A method for performing a leak test on a gas generator (1), comprising:
filling the gas generator (1) with a pressurized gas mixture that includes helium, wherein the gas generator (1) is filled with a gas mixture whose helium proportion is equal to at least 50%;
introducing the gas generator (1) into a test chamber (2);
evacuating the gas mixture from the test chamber (2);
sensing an amount of helium exiting from a possibly present leak with a sensor device, the sensor being configured to provide a sensor signal; and
determining the amount of helium exiting from the possibly present leak from the signal furnished by the sensor.

2. The method in accordance with claim 1, wherein the helium proportion is between 80% and 100%.

3. The method of claim 2, wherein the helium proportion is substantially between 90 and approximately 100%.

4. The method of claim 1, wherein the gas generator includes an airbag.

5. The method in accordance with claim 1, wherein the test chamber (2) includes at least one flexible wall (5, 6).

6. A method for performing a leak test on a gas generator, the method comprising:
filling the gas generator (1) with a pressurized gas mixture that includes helium, wherein the gas generator (1) is filled to 100% with helium;
introducing the gas generator (1) into a test chamber (2);
evacuating the gas is evacuated from the test chamber (2);
sensing an amount of helium exiting from a possibly present leak with a sensor device, the sensor being configured to provide a sensor signal; and
determining the amount of helium exiting from the possibly present leak from the signal furnished by the sensor.

7. The method in accordance with claim 6, wherein the test chamber (2) includes at least one flexible wall (5, 6).

8. The method in accordance with claim 7, wherein the leak test is performed in a foil test chamber.

9. An apparatus for performing a leak test on a gas generator (1), the apparatus comprising:
a gas source configured to fill the gas generator (1) with a pressurized gas mixture that includes helium, the gas mixture including a helium proportion equal to at least 50%;
a test chamber (2) configured to accommodate the gas generator (1), the test chamber including at least one flexible wall (5,6);
a gas evacuation mechanism configured to evacuate the gas mixture from the test chamber (2);
a sensor for determining an amount of helium exiting from a possibly present leak, the sensor providing a signal corresponding to a measurement of the tightness/leakage of the gas generator (1); and
an analyzer coupled to the sensor, the analyzer being configured to determine the tightness/leakage of the gas generator (1) based on the signal.

10. The apparatus of claim 9, wherein the gas generator is filled with a gas mixture including a helium proportion that amounts to at least 50%.

11. The apparatus of claim 10, wherein the helium proportion is between 80% and 100%.

12. The apparatus of claim 11, wherein the helium proportion is substantially within a range between 90% and approximately 100%.

13. The apparatus of claim 10, wherein the helium proportion is approximately 100%.

14. The apparatus of claim 9, wherein the gas generator includes an airbag.

15. The apparatus of claim 9, wherein the at least one flexible wall (5,6) includes a plurality of flexible walls.
